(19) United States
(12) Patent Application Publication
(10) Pub. No.: US 2013/0236758 A1
(43) Pub. Date: Sep. 12, 2013

(54) BATTERY TRAY COVER FOR UNDERGROUND MINING EQUIPMENT

(71) Applicants: Ray Deel, Abingdon, VA (US); William Jubeck, Seneca, PA (US); Anthony Faccio, Oil City, PA (US)

(72) Inventors: Ray Deel, Abingdon, VA (US); William Jubeck, Seneca, PA (US); Anthony Faccio, Oil City, PA (US)

(21) Appl. No.: 13/440,232

(22) Filed: Apr. 5, 2012

Related U.S. Application Data
(60) Provisional application No. 61/609,807, filed on Mar. 12, 2012.

(51) Int. Cl. H01M 2/10; H01M 2/04

(52) U.S. Cl. 429/99

(57) ABSTRACT

A battery-powered mining machine comprising a battery tray, including an upper lip, a plurality of batteries in the battery tray to provide power to the mining machine, and a battery tray cover mounted on the battery tray for enclosing the batteries in the battery tray. The battery tray cover comprising at least one panel made entirely of plastic and including a top surface, a bottom surface engaging, when the battery tray cover is closed, the upper lip of the battery tray, and a continuous side surface between the top surface and the bottom surface.

### RELATED APPLICATION

This application claims priority to co-pending U.S. Provisional Patent Application No. 61/609,807 filed on Mar. 12, 2012, the entire content of which is incorporated herein by reference.

### BACKGROUND

The present invention relates to a plastic battery tray cover for use in connection with underground mining equipment, specifically battery-powered haulers. Traditional underground mining equipment battery covers are made of steel or fiberglass. The strength of the steel protects the battery from falling debris, which is encountered in underground mines.

### SUMMARY

Traditional steel battery tray covers have created several problems. Since steel is conductive and subject to corrosion, it must be coated with a non-conducting, non-flammable, and non-corrosive coating in order to meet Mine Safety and Health Administration (MSHA) requirements. The coating process is expensive and not completely effective since the available coatings deteriorate with time and the battery tray cover must eventually be stripped and recoated. In addition, the traditional steel battery cover is heavy, weighing approximately 620 pounds. This weight increases the time and effort required to service the battery. The additional weight of the traditional steel battery cover also increases the load of underground mining machine components and increases the amount of energy used by the machine. Traditional fiberglass battery tray covers are lightweight. However, the fibers of the fiberglass battery tray covers have a potential to wick and retain acid from the batteries. Once a fiberglass battery tray cover retains acid from the batteries it becomes conductive.

A battery tray cover embodying the invention overcomes these problems by being composed of polyurethane plastic. This construction inherently meets MSHA requirements of being non-conductive, non-flammable, and not subject to corrosion, while still protecting the battery tray and the batteries enclosed therein from falling debris. This construction also has the added benefit of being light-weight. The approximate weight of a battery tray cover embodying the present invention is 138 pounds, which is a reduction in weight of 78% from traditional steel battery covers.

In one embodiment, the invention provides a battery-powered mining machine comprising a battery tray, including an upper lip, a plurality of batteries in the battery tray to provide power to the mining machine, and a battery tray cover mounted on the battery tray for enclosing the batteries in the battery tray. The battery tray cover comprising at least one panel made entirely of plastic and including a top surface, a bottom surface engaging, when the battery tray cover is closed, the upper lip of the battery tray, and a continuous side surface between the top surface and the bottom surface.

In another embodiment the invention provides a battery tray cover mounted on a battery tray for enclosing one or more batteries in the battery tray, the battery tray cover comprising at least one panel made entirely of plastic. The panel including a top surface, a bottom surface engaging, when the battery tray cover is closed, an upper lip of a battery tray, and a continuous side surface between the top surface and the bottom surface.

Other aspects of the invention will become apparent by consideration of the detailed description and accompanying drawings.

### BRIEF DESCRIPTION OF THE DRAWINGS

FIG. 1 shows a battery-powered mining hauler including a battery tray and a battery tray cover embodying the invention.

FIG. 2 shows an enlarged view of the battery tray cover, illustrating two battery tray cover panels connected together by a hinge.

FIG. 3 is a view of the bottom surface of the battery tray cover shown in FIG. 2.

FIG. 4 shows a battery tray and battery tray cover in accordance with the present invention.

FIG. 5 shows a battery tray with a portion of the battery tray cover partially removed.

FIG. 6 shows a close-up view of fasteners for securing the battery tray cover to the battery tray.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Also, although directional references, such as upper, lower, downward, upward, rearward, bottom, front, rear, etc., may be made herein in describing the drawings, these references are made relative to the drawings (as normally viewed) for convenience. These directions are not intended to be taken literally or limit the present invention in any form. In addition, terms such as “first,” “second,” and “third” are used herein for purposes of description and are not intended to indicate or imply relative importance, significance, or ordering unless otherwise indicated.

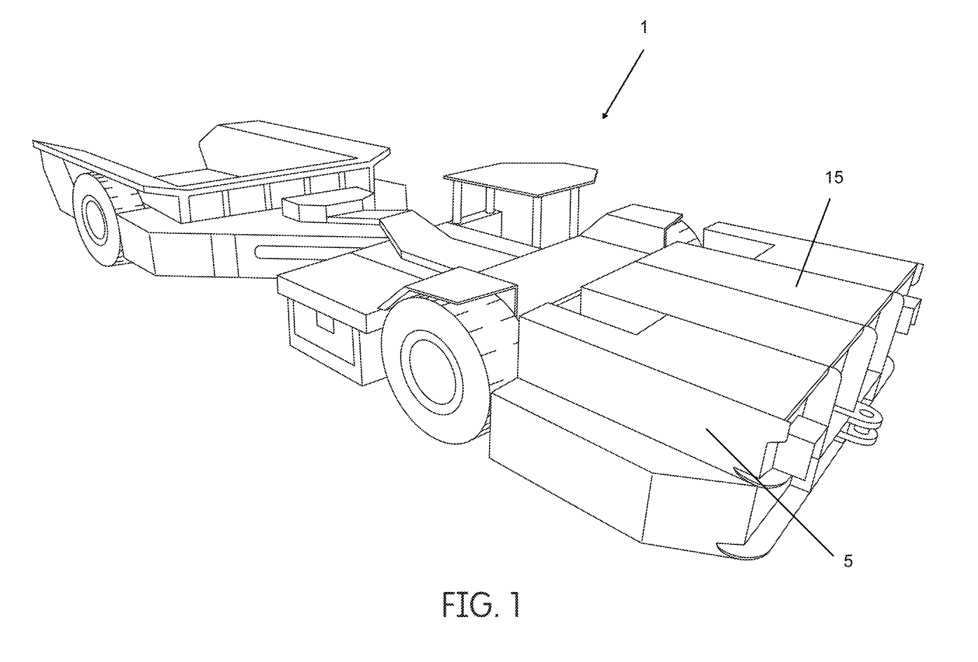

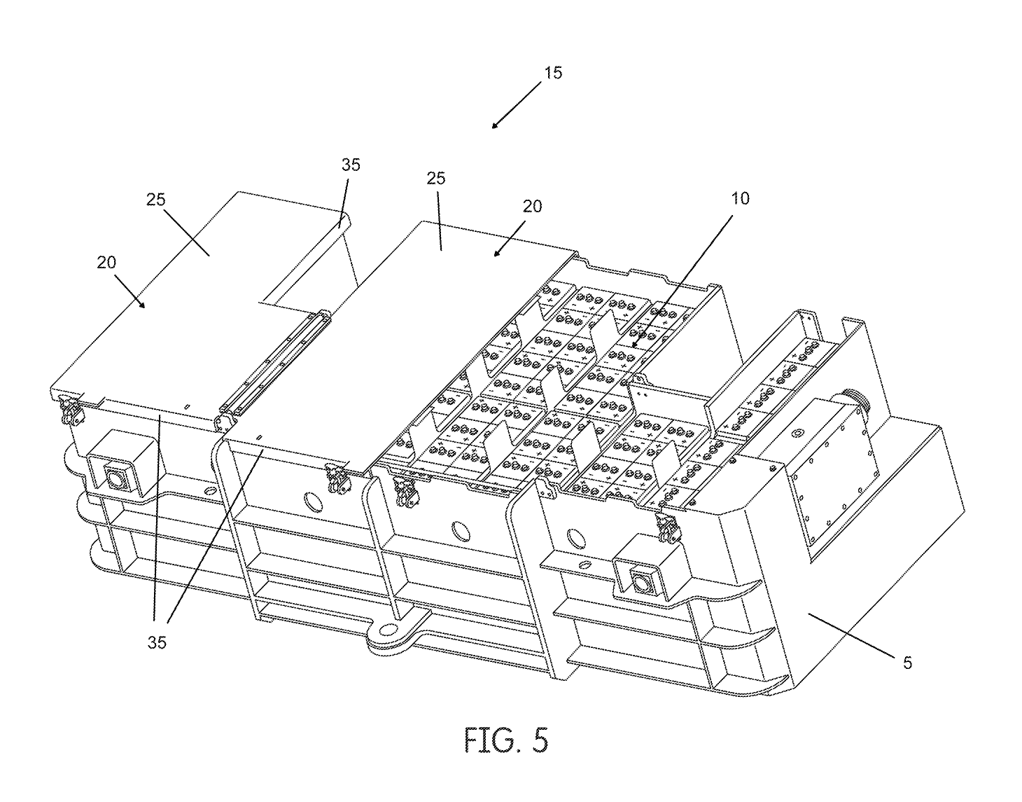

FIG. 1 shows a battery-powered mining hauler 1. The battery-powered mining hauler 1 is used to transport mined material in underground mining operations. The battery-powered mining hauler 1 generally comprises a chassis, a battery tray 5, one or more batteries 10 (shown in FIG. 5), and a battery tray cover 15. The chassis of the mining hauler 1 contains the battery tray 5. The battery tray 5 includes sidewalls and an upper edge or lip. As shown in FIG. 5, the batteries 10 are enclosed within the sidewalls of the battery tray 5 and covered by the battery tray cover 15. The batteries 10 provide DC power to the battery-powered mining hauler 1.

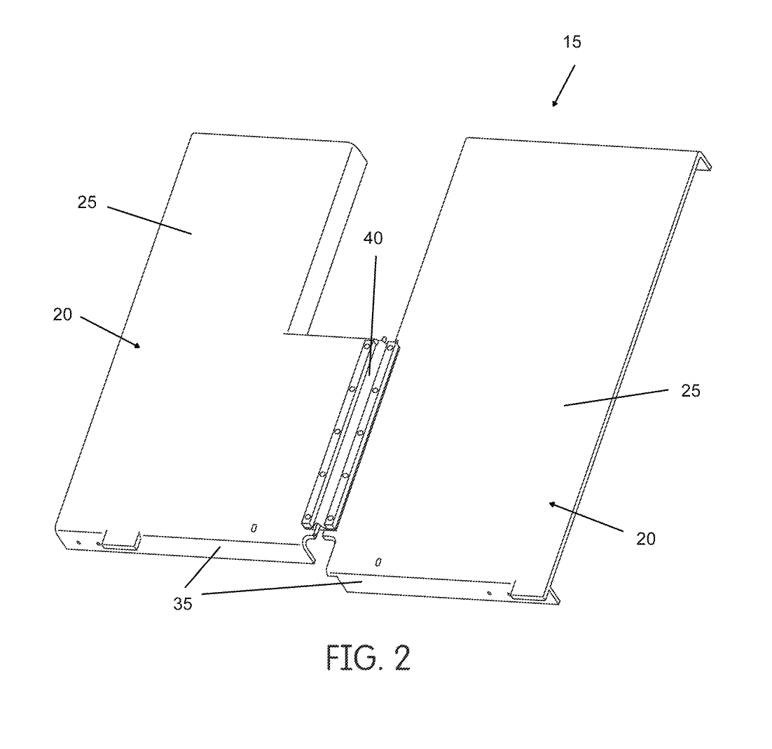

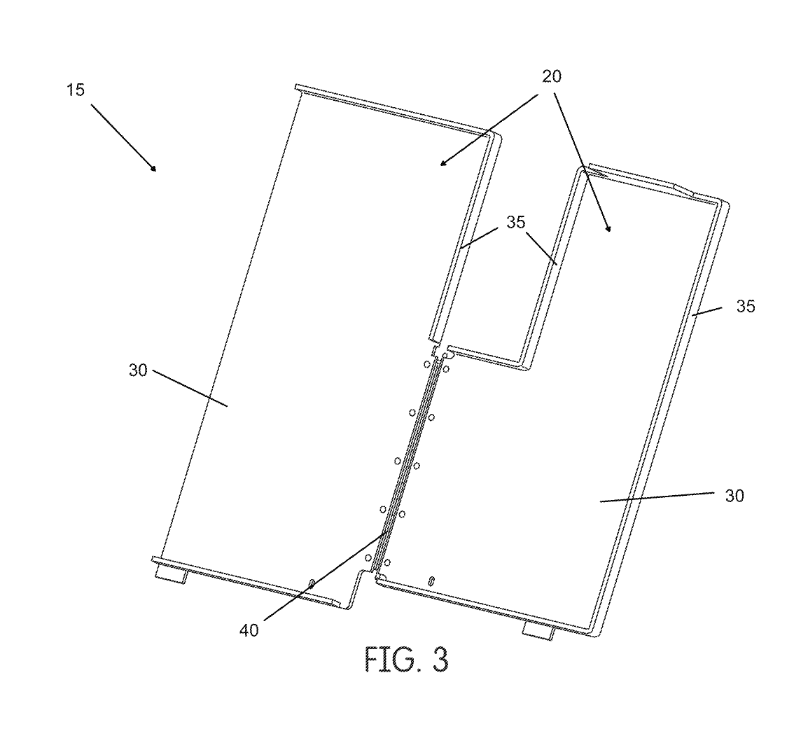

FIGS. 2 and 3 show a battery tray cover 15 in accordance with the present invention. The battery tray cover 15 includes cover panels 20. In one embodiment the cover panels 20 are made of plastic, which may include any of, or any combination of polyurethane, polypropylene, polyethylene, or similar plastic. The cover panels 20 include a top surface 25 and a bottom surface 30. The cover panels define a continuous side surface 35 between the top surface 25 and bottom surface 30.

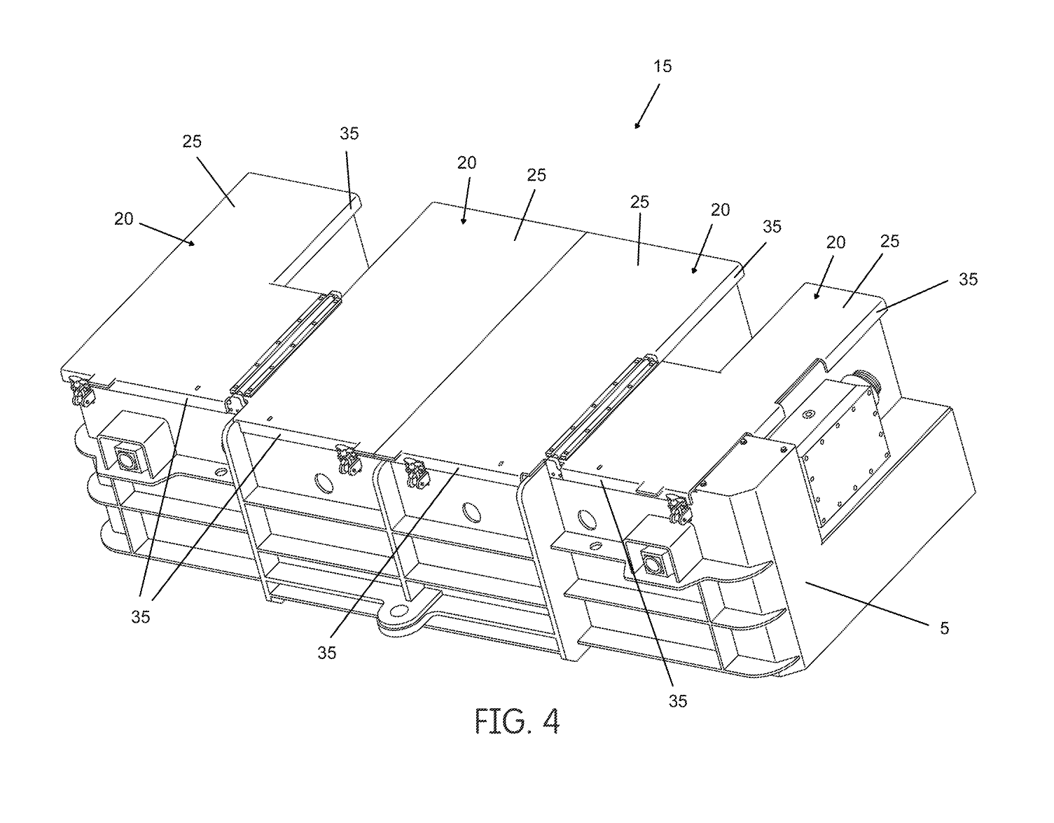

As shown in FIGS. 4 and 5 when the battery tray cover 15 covers the battery tray 5, the side surface 35 defines a shroud, or overhang, around the upper lip of the battery tray 5. The side surface 35 also acts as a lift tab to facilitate lifting the cover panels 20.

The cover panels 20 are connected by hinges 40. In one embodiment the hinges 40 are made out of metal. The hinges 40 allow access to compartments of the battery tray 5 without the need to remove the entire battery tray cover 15.

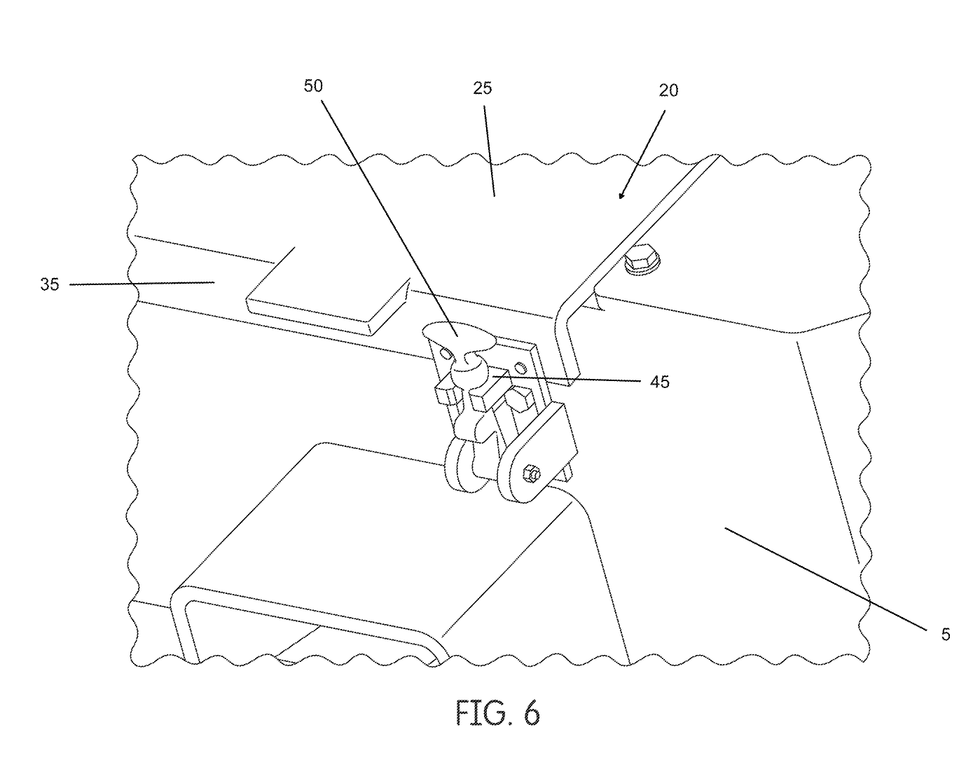

As shown in FIG. 6, the battery tray cover 15 also has fasteners 45, which attach the battery tray cover 15 to the battery tray 5. In one embodiment, the fasteners 45 are also composed of plastic and are attached to the side surface 35. A rubber hook 50, which is attached to the battery tray 5, is then used to fasten the battery tray cover 15 to the battery tray 5. In another embodiment, the fasteners 45 are composed of metal or similar material.

The cover panels 20 of the battery tray cover 15 can be created using injection molding with plastic. By using plastic, the battery tray cover 15 inherently meets Mine Safety and Health Administration (MSHA) requirements, of being non-conductive, non-flammable, and non-corrosive. Using plastic for the entire battery tray cover 15, rather than just a coating also prevents cracking, peeling, etc. Further, the battery tray cover 15 is light weight, because of the lightweight nature of plastics.

Even though made of plastic, the battery tray cover 15 is as durable as previous metal battery covers. The battery tray cover 15 is able to withstand falling debris, and other elements frequently encountered in underground mining operations.

Thus, the invention provides, among other things, a plastic battery cover for underground mining equipment. Various features and advantages of the invention are set forth in the following claims.

What is claimed is:

1. A battery-powered mining machine comprising:
a battery tray, including an upper lip;
a plurality of batteries in the battery tray to provide power to the mining machine; and
a battery tray cover mounted on the battery tray for enclosing the batteries in the battery tray, the battery tray cover comprising at least one panel made entirely of plastic and including a top surface, a bottom surface engaging, when the battery tray cover is closed, the upper lip of the battery tray, and a continuous side surface between the top surface and the bottom surface.

2. A battery-powered mining machine as set forth in claim 1, wherein the side surface defines a shroud for covering the interface between the bottom surface of the battery tray cover and the upper lip of the battery tray.

3. A battery-powered mining machine as set forth in claim 1, where the side surface defines a lift tab for opening the battery tray cover.

4. A battery-powered mining machine as set forth in claim 1, wherein the battery tray cover comprises a plurality of plastic injection molded panels.

5. A battery-powered mining machine as set forth in claim 4, wherein the battery tray cover comprises two panels connected together by a hinge.

6. A battery-powered mining machine as set forth in claim 1, wherein the at least one panel is made of plastic, which may include any of, or any combination of polyurethane, polypropylene, or polyethylene.

7. A battery-powered mining machine as set forth in claim 1, wherein the battery tray cover weighs 20% to 50% of known battery tray covers for mining machines.

8. A battery-powered mining machine as set forth in claim 1, and further comprising at least one fastener for attaching the battery tray cover to the battery tray.

9. A battery-powered mining machine as set forth in claim 7, wherein the fastener is composed of plastic.

10. A battery-powered mining machine as set forth in claim 7, wherein the fastener is composed of metal.

11. A battery tray cover mounted on a battery tray for enclosing one or more batteries in the battery tray, the battery tray cover comprising:
at least one panel made entirely of plastic, the panel including
a top surface,
a bottom surface engaging, when the battery tray cover is closed, an upper lip of a battery tray, and
a continuous side surface between the top surface and the bottom surface.

12. A battery tray cover as set forth in claim 11, wherein the battery tray cover comprises a plurality of plastic injection molded panels.

13. A battery tray cover as set forth in claim 12, where the battery tray cover comprises two panels connected together by a hinge.

14. A battery tray cover as set forth in claim 11, wherein the battery tray cover weighs 20% to 50% of known battery tray covers for mining machines.

15. A battery tray cover as set forth in claim 11, wherein the at least one panel is made of plastic, which may include any of, or any combination of polyurethane, polypropylene, or polyethylene.

16. A battery-powered mining machine comprising:
a chassis;
a battery tray, including an upper lip, the battery tray mounted to the chassis;
a plurality of batteries in the battery tray to provide power to the mining machine; and
a battery tray cover mounted on the battery tray for enclosing the batteries in the battery tray, the battery tray cover comprising at least one panel made entirely of plastic and including a top surface, a bottom surface engaging, when the battery tray cover is closed, the upper lip of the battery tray, and a continuous side surface between the top surface and the bottom surface.

17. A battery-powered mining machine as set forth in claim 16, wherein the side surface defines a shroud for covering the interface between the bottom surface of the battery tray cover and the upper lip of the battery tray.

18. A battery-powered mining machine as set forth in claim 16, where the side surface defines a lift tab for opening the battery tray cover.

19. A battery-powered mining machine as set forth in claim 16, wherein the battery tray cover comprises a plurality of plastic injection molded panels.

20. A battery-powered mining machine as set forth in claim 19, wherein the battery tray cover comprises two panels connected together by a hinge.

21. A battery-powered mining machine as set forth in claim 16, wherein the at least one panel is made of plastic, which may include any of, or any combination of polyurethane, polypropylene, or polyethylene.

22. A battery-powered mining machine as set forth in claim 16, wherein the battery tray cover weighs 20% to 50% of known battery tray covers for mining machines.

23. A battery-powered mining machine as set forth in claim 16, and further comprising at least one fastener for attaching the battery tray cover to the battery tray.
